(19) United States
(12) Patent Application Publication
(10) Pub. No.: US 2023/0171145 A1
(43) Pub. Date: Jun. 1, 2023

(54) Server, Client, Methods and Program Codes

(71) Applicant: Intel Corporation, Santa Clara (US)

(72) Inventors: Mona HOSSAIN, San Jose, CA (US); Sanjay KUMAR, Hillsboro, OR (US); Utkarsh Y. KAKAIYA, Folsom, CA (US)

(21) Appl. No.: 17/446,974

(22) Filed: Sep. 6, 2021

(51) Int. Cl. H04L 12/24

(52) U.S. Cl. CPC H04L 41/06; H04L 41/14

(57) ABSTRACT

A server is provided. The server comprises one or more interfaces configured to communicate with a client and processing circuitry configured to control the one or more interfaces and to transmit an interrupt to the client informing the client about an operation state of the server.

### FIELD

The present disclosure relates to the field of communication between a server and a client. In particular, examples relate to a server, a client, methods and program codes.

### BACKGROUND

Communication between server and client is mainly focused on transmission of work from the client to the server, e.g., by use of a request, and a processing result from the server to the client. However, if for some reason the server is not capable to process the work addressed by the client, an ongoing operation may fail and data corresponding to this work may be lost. Thus, there may be a need to improve a communication between the client and the server.

### BRIEF DESCRIPTION OF THE FIGURES

Some examples of apparatuses and/or methods will be described in the following by way of example only, and with reference to the accompanying figures, in which

FIG. 1 shows a block diagram of an example of a server;

FIG. 2 shows a block diagram of an example of a client;

FIG. 3 shows a flow diagram of an example of a method;

FIG. 4 shows a block diagram of an example of a method for a server; and

FIG. 5 shows a block diagram of an example of a method for a client.

### DETAILED DESCRIPTION

A server may need to go to an inactive operation state, in which the server may be not capable to process any further work addressed by the client. For example, when a firmware is being updated on the server, e.g. by a hypervisor like a Virtual Machine Monitor (VMM) while the server is assigned to a client, e.g. a virtual machine (VM). In this case the server may not be able to accept/process a new work/request during the update. For example, when a VM is being migrated and is assigned to a physical server. The server may be put in a paused operation state e.g., by a VMM during the migration of the VM and may not be able to accept any new work/request from the VM.

In both cases the client, e.g., a guest (VM) software (SW) is not aware that it shouldn't submit work to the server, and hence it may continue to submit work. This may cause the ongoing operation to fail (e.g., a firmware upgrade may fail) or worse it may cause the input/output (I/O) work to be lost (e.g., the VM got migrated to a destination while its work still wasn't processed on the source server). When I/O work is lost, the client and the server may get out of synch. To prevent the client from submitting work to an inactive server the client can be informed about the operation state of the server. This way a disturbance of the ongoing operation may be prevented.

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

Some embodiments may have some, all, or none of the features described for other embodiments. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform or resource, even though the instructions contained in the software or firmware are not actively being executed by the system, device, platform, or resource.

The description may use the phrases “in an embodiment,” “in embodiments,” “in some embodiments,” and/or “in various embodiments,” each of which may refer to one or more of the same or different embodiments. Furthermore, the terms “comprising,” “including,” “having,” and the like, as used with respect to embodiments of the present disclosure, are synonymous.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e. only A, only B as well as A and B. An alternative wording for the same combinations is “at least one of the group A and B”. The same applies for combinations of more than 2 Elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

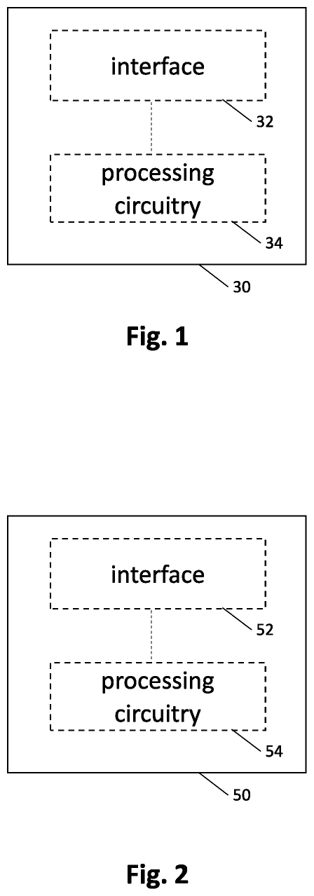

FIG. 1 shows a block diagram of an example of a server 30. The server 30 comprises one or more interfaces 32 configured to communicate with a client and processing circuitry 34 configured to control the one or more interfaces 32 and to transmit an interrupt to the client informing the client about an operation state of the server. Thus, the client can be informed by the server about an operation state of the server. This way the client may stop transmitting work to the server, e.g., without suspending the client, e.g. suspending a guest/VM by use of a VMM, before bringing the server into an inactive operation state.

By transmitting the interrupt several issues belonging the server/client can be solved. For example, as part of preparing a client, e.g., a guest VM, for live migration from a server it resides on (source server) to another server (destination server), it is essential to ensure that the virtual server(s) associated with the client is quiesced properly. This may involve draining all the previously submitted requests in a server, e.g., a hardware (HW) and clearing all queues in the HW of any pending requests. The HW of the server shall process all the previously submitted request descriptors. If memory address(es) in submitted descriptor include guest VM virtual address, processing that descriptor may result in I/O page fault. But since the vCPUs are in a paused operation state these page faults cannot be resolved successfully and the virtual server cannot be quiesced. This failure to quiesce virtual server, will prevent a successful live migration of the guest VM. Thus, by informing the client about an operation state of the server, the need to bring the client to a quiesce operation state is omitted, since the interrupt may guarantee that the client does not transmit work to an inactive server. This way also the server may not require a hypervisor to wait for all submitted work from the client to complete.

Further, some clients such as Shared Virtual Memory (SVM) in a VM (a.k.a. virtual SVM) may require the VM's vCPUs to be alive when the server is being paused. This is because vSVM may cause I/O page faults in the guest page table and may require guest operation system to resolve the page fault before the server can be paused. For example, work may be submitted to a server, e.g., comprising an accelerator HW via a work descriptor. This descriptor points to some memory that have information accessed by the HW of the server. In cases where these memory addresses are guest virtual address and respective memory is not paged in, when the HW of the server tries to access the memory, it will result in page faults. The page faults need resolving by the client, e.g., a guest VM, allowing the HW of the server to complete processing the work successfully. Hence the guest VM needs to be active and in a running operation state when the work is being processed by the HW of the server. Essentially, in order to allow the HW of the server to complete processing the submitted work descriptor, the virtual CPUs (vCPU) associated with the guest VM shall not be in a paused operation state.

As a part of a last phase of live migration, to pause all activities in the client, which include work submission by client, a hypervisor may pause all vCPUs associated with the client. Thereby, pausing the client, e.g., the guest VM. Thus, by transmitting an interrupt comprising information about an operation state of the server, the client can be kept in an active operation state, since the client can be informed not to transmit further work to the client.

By utilizing the interrupt the server can reach an inactive operation state, e.g., a quiescent operation state, where HW of the server (e.g., accelerator HW) may have completed processing of all submitted in-flight work (e.g., all requests transmitted by the client) from a client. Further, it can be ensured that no new work (e.g., a new request) can be directly submitted to the server, e.g., the HW before the server is ready to accept new requests again. When the server is ready to accept new work (e.g., after being migrated to a new destination host, or after server firmware has been updated successfully), clients shall be allowed to submit work directly to the HW of the server.

Some devices specification recommend that software keep count of credits used to ensure not submitting to a full queue. But this only addresses scenarios when there is no space in HW to accept new submissions and not specifically other reasons when the HW of a server is unable to accept new submissions.

Further, a hypervisor may intercept and emulate work submissions by a client during live migration or firmware upgrade. To address the failure to quiesce a server due to unresolved page faults when processing previously submitted work in a HW of the server, additional support in the hypervisor may be required. The hypervisor (e.g., a VMM) may emulate the work submission instructions (e.g., MOVDIR, ENQCMD/ENQCMDS, etc.) used to submit a workload, thereby allowing the hypervisor to intercept all work submission from the client and preventing direct submission to the server, e.g., the HW. By utilizing the interrupt this complex process can be eased, e.g., emulate CPU instruction used to submit work descriptor, submitted request shall be addressed and resolved by the client, which is still running, pause the client, etc. can be omitted. Thus, a complexity in the hypervisor can be reduced, e.g., a complexity with queuing in work in SW on a source host and de-queuing it on the destination host.

For example, the interrupt may define an architecturally supported mechanism to allow the server to signal a client (e.g., including a guest VM) to hold off work submission when it is about to go into an inactive (e.g., a paused) operation state. Further, the interrupt may subsequently notify the client to resume once the server is in an active operation state again and ready to accept new work submitted by the client. This may enable a hypervisor to avoid complexity of intercepting and emulating work submission from the client in live migration support. Moreover, this interface defined by the interrupt can be used as a standard interface across all hypervisors, so that developing hypervisor specific solutions can be omitted.

The interrupt may be integrated into a design of a communication protocol to notify the client about an operation state of the server. In an example, the interrupt may be a pause interrupt informing the client about an inactive operation state of the server. An inactive operation state may be each (operation) state in which the server cannot process work received from the client, e.g., a quiesce operation state, a shut-down state, etc. Thus, the server can inform the client about an inactive operation state and the client may stop to transmit work to the server, which may prevent a data loss.

The pause interrupt (also referred as “PAUSE_WORK_SUBMISSION”) may be a miscellaneous interrupt integrated, e.g., in the HW of the server, e.g., an accelerator device. On receiving the PAUSE_WORK_SUBMISSION, the client, e.g., a SW shall take appropriate measures to ensure not to submit further work to the server.

In an example, the information about the inactive operation state of the server may be information about a planned inactive operation state of the server. A planned inactive operation state may be an inactive operation state in the future, e.g., in a predefined time. For example, the predefined time may be a time required by the client to receive and process the pause interrupt. This way the server can ensure that no further work is transmitted by the client, since the client has enough time to receive and process the pause interrupt. For example, the predefined time may depend on a client type. For example, the pause interrupt may be a heads-up and the operation state may be not quiesced directly after transmitting the pause request.

In an example, the interrupt may be a resume interrupt informing the client about a termination of an inactive operation state of the server. Thus, if an inactive operation state of the server is terminated (e.g., the server is in an active operation state) the client can be informed in an eased way that the server is (again) capable to receive further work.

The resume interrupt (also referred as “RESUME_WORK_SUBMISSION”) may be a miscellaneous interrupt (different from the PAUSE_WORK_SUBMISSION) integrated, e.g., in the HW of the server, e.g., an accelerator device. On receiving the RESUME_WORK_SUBMISSION, SW shall take appropriate measures to resume/allow work submission to the HW of the server.

For example, two different miscellaneous interrupts may be introduced in the HW of the server, e.g., an accelerator device, namely the PAUSE_WORK_SUBMISSION and the RESUME_WORK_SUBMISSION. With these both interrupts the server is capable of informing the client about a beginning of an inactive operation and the termination of the inactive operation state.

In an example, the processing circuitry 34 may be further configured to receive reception information about a processing of the interrupt from the client. Thus, the server can be informed that the client may transmit no further work to the server. The reception information may be used optionally or alternatively to the information about a planned inactive operation state. For example, if the server transmits a request to the client and receives the reception information from the client the server may begin to go to an inactive operation state independently of an exceedance of the predefined time. For example, if the server does not receive the reception information the server may begin to go to an inactive operation state after an exceedance of the predefined time or alternatively the server may only begin to go to an inactive operation state after receiving the reception information.

The reception information (also referred as acknowledgment (information)) can be integrated by an acknowledgement register, e.g., “Device Suspended”, that can be used by the client to notify the HW of the server that it has processed the PAUSE_WORK_SUBMISSION and no new work will be submitted to the server.

In an example, the processing circuitry 34 may be further configured to request the reception information. Thus, the server can ensure that the interrupt, e.g., the resume interrupt was processed. For example, if required by the request of the reception information (e.g., indicated by a CAPABILITY SDA bit setting), a SW can set a DEVICE SUSPENDED register bit in a server register to “1” indicating that the SW of the client has processed the interrupt. Further, the DEVICE_SUSPENDED register bit can be cleared by the HW of the server before transmitting a RESUME_WORK_SUBMISSION or a new PAUSE_WORK_SUBMISSION. Thus, it can be ensured that an indication in the DEVICE_SUPSENDED register bit of a processing of each pause interrupt is correctly.

In an example, the reception information may further comprise information about a flush out of all pending requests of the client addressed to the server. Thus, the server can be informed that all work transmitted from the client to the server has been completed/paused, which ensures that no further work arrives at the server.

In an example, the processing circuitry 34 may be further configured to allow the server to enter the inactive operation state only after receiving the reception information. Thus, it can be ensured that the server only begins to go to an inactive operation state if it is guaranteed that no further work will be transmitted by the client to the server. For example, the client has to wait for a notification and may go to an inactive operation state after receiving the reception information, e.g., an acknowledgement. Alternatively, the client may go to an inactive operation state irrespective of an acknowledgement (e.g., override/recovery path in case of malicious client), for example the reception information may comprise no acknowledgment or no reception information may be received.

In an example, the processing circuitry 34 may be further configured to transmit a client pause timer to the client, wherein the client pause timer defines a timeout delay between receiving the pause request and transmitting a new request to the server. Thus, the server can inform the client about a maximum duration of an inactive operation state. For example, the server may need to restart and may know the duration of the restart so that the server can inform the client about the duration of the restart, or the server may need an update and an update duration is known, such that the update duration can be provided to the client.

In an example, the processing circuitry 34 may be further configured to define the timeout delay of the client pause timer. Thus, the server can adjust the client pause timer, e.g., in dependency of an inactive operation state, such like a restart, an update, etc.

In an example, the processing circuitry 34 may be further configured to use a server pause timer, wherein the server pause timer defines a timeout delay between transmitting the pause request and entering the inactive operation state. The server pause timer can be used in combination with the pause interrupt informing about the planned inactive operation station. For example, the server pause timer may comprise the predefined time, e.g., the timeout delay of the server pause timer may be given by the predefined time.

In an example, the processing circuitry 34 may be further configured to receive the timeout delay of the server pause timer from the client. Thus, the server pause timer can be adapted and eased to a specification of the client.

In an example, the processing circuitry 34 may be further configured to transmit the interrupt by use of a peripheral component interconnect, PCI, register and/or a hardware register, which is exposed through memory-mapped input/output. Thus, the implementation of the interrupt can be performed in an eased way.

For example, the one or more interfaces 32 may be a PCI and the interrupt can be integrated through an extended PCI capability “Device Suspend Capability” (DSC) in the server PCI register (configuration space). If the PCI capability indicates that DSC is supported, the SW of the client may choose to add support to process the interrupt, e.g., the pause interrupt or the resume interrupt, that indicate the client to stop or resume work transmission. If the SW of the client chooses to support the DSC capability, it may opt-in (e.g., enable) the interrupt receiving/processing.

The proposed integration into the DSC capability can be supported by a plurality of different servers, e.g., different accelerator devices, which allows a more standardized design, e.g., a more standardized live migration design. Further, the DSC capability can be supported on a plurality of operation systems and a plurality of hypervisors.

For example, as long as the SW (e.g., of the guest driver/client and host driver) implements the communication protocol as defined in the server specification, no additional changes to the hypervisor may be required. Further, there is no need for the hypervisor to emulate instruction (current and future) for work transmission to the HW of the server.

For example, the DSC can be used in designing a solution to prevent the SW of a client from submitting work to the HW of a server when the server is updating firmware. When the server SW (e.g. a firmware) is being updated while the client is assigned to the server and used by a VM, the hypervisor can configure the server to signal the client to stop submitting any new work to the HW of the server using the pause interrupt. The server can then go into an inactive operation state (e.g. a quiesce operation state), in which all pending requests have been completely processed. After updating the SW on the server, the hypervisor can signal the client to resume work submission using the resume interrupt.

By integrating the interrupt in the DSC register and/or the server register of the server a mechanism to architecturally support holding off the SW of the client from transmitting work to a server HW, e.g., a PCI can be provided. The server HW may go into an inactive operation state where it is unable to accept work transmission from the SW of the client or alternatively, a VMM may want to bring the server HW into an inactive operation state where it shouldn't accept work from a VM SW of the client. Thus, a SW, e.g., a firmware of the server can be updated on the server HW by the VMM while the server is assigned to a client, e.g., a guest VM. Also the architecturally support may allow a client, e.g., a VM to being migrated with an assigned server and the server shouldn't accept any more work from the client during the migration period.

In an example, the processing circuitry 34 may be further configured to set the PCI register and/or the server register to indicate a support of the interrupt (e.g., setting a bit in the respective register). In an example, the processing circuitry 34 may be further configured to set the PCI register and/or the server register to indicate a support of the reception information. In an example, the processing circuitry 34 may be further configured to set the PCI register and/or the sever register to indicate required reception information about receiving the interrupt from the client (e.g., by setting a reception bit in the respective register). Thus, the server can define appropriate measures.

This mechanism to architecturally support can be integrated as a part of a server vendor specific extended PCI capability, e.g., by setting a bit as described above. Following is a proposal to add a new PCI extended capability for supporting a DSC.

A device vendor specification may be described as follow:

| | | | | | |
|---|---|---|---|---|---|
| Offset | 31:28 | 27:24 | 23:20 | 19:16 | 15:0 |

| | | | |
|---|---|---|---|
| 0 | Next Capability Off- | Cap version | PCI Express Extended Capability ID = 0×23 |
| | set | | |
| 4 | DVSEC Length = | DVSEC rev = 0 | DVSEC Vendor ID = 8086 |
| | 0×10 | | |

| 8 | CAPABILITY | |
|---|---|---|
| 12 | CONTROL | |
| 16 | MIN_PAUSE_TIME | DEVICE SUSPENDED |

Definition of the CAPABILITY Field at Offset 0×8 Byte:

| Bit | Description | Attributes |
|---|---|---|
| 0 | PR (Pause/Resume Work Submission Interrupt): | RO |
| | The PR flag bit when set, may indicate that a device HW supports both | |
| | PAUSE_WORK_SUBMISSION and RESUME_WORK_SUBMISSION. | |
| | If DSC is enabled (e.g., CONTROL.DCS_ENABLE bit is set by SW), the | |
| | device may generate aPAUSE_WORK_SUBMISSION signal when HW is | |
| | not able to accept any more new workload and at the same time it may ini- | |
| | tiate a timer (e.g. a client pause timer or server pause timer). Later, HW may | |
| | generate a RESUME_WORK_SUBMISSION when the HW is ready to ac- | |
| | cept new work. | |
| | If PR flag is not set, device HW is not capable of generating interrupts | |
| | (PAUSE_WORK_SUBMISSION or RESUME_WORK_SUBMISSION) | |
| | to signal its state with respect to being able to accept workload. | |
| | The actual interrupts (i.e., MSI-X table entry) used by the device is device- | |
| | specific. | |
| 2 | SDA (Suspend Device Acknowledgement): | RO |
| | The SDA flag bit may be used to indicate if HW will rely on acknowledg- | |
| | ment (reception from SW with regards to it having completed processing | |
| | the PAUSE_WORK_SUBMISSION) or only on previously set | |
| | MIN_PAUSE_TIME expiration, before HW fires the RESUME_WORK | |
| | SUBMISSION interrupt. | |
| | The SDA flag bit when set and is enabled (and both CONTROL.DCS_EN- | |
| | ABLE and CONTROL.SDA_ENABLE bits are set), may indicate device | |
| | HW requires acknowledgement/reception information from SW on having | |
| | completed processing the PAUSE_WORK_SUBMISSION before device | |
| | HW can fire the RESUME_WORK_SUBMISSION. Software MUST set | |
| | the “Device Suspended” register on receiving the PAUSE_WORK_SUB- | |
| | MISSION, essentially acknowledging SW has taken appropriate step in en- | |
| | suring no further request will be submitted to HW. Furthermore, when SDA | |
| | flag bit is set, device HW may clear the “Device Suspended” register prior | |
| | to firing the RESUME_WORK_SUBMISSION. | |
| | If SDA flag is not set, HW may not wait on the “Device Suspended” register | |
| | to be set prior to firing the RESUME_WORK_SUBMISSION. Further- | |
| | more, HW may not clear the “Device Suspended” register before firing the | |
| | RESUME_WORK_SUBMISSION. If timer (e.g., client pause timer) is sup- | |
| | ported by the device HW (CPABILITY.TMR bit is set), HW may essentially | |
| | fire the resume interrupt after a time as set in the MIN_PAUSE_TIME has | |
| | expired and HW is ready to accept new requests. | |
| 3 | TMR | RO |
| | The TMR flag bit may be used to indicate if HW supports timer functional- | |
| | ity. | |
| | When set to 1, a timer is started after the device issues a | |
| | PAUSE_WORK_SUBMISSION. | |
| | When set to 0, timer functionality is not supported. | |
| 7:4 | Reserved | RO |

Definition of the CONTROL Register Bits at Offset 0xc (12B):

| Bit | Description | Attributes |
|---|---|---|
| 0 | DCS_ENABLE | RW |
| | SW may set this bit to 1 to enable Device Suspend Capability. Enabling this, | |
| | results in HW being capable of firing PAUSE_WORK_SUBMISSION and | |
| | RESUME_WORK_SUBMISSION based on device state. | |
| | SW may set this bit to 0 to disable Device Suspend Capability. When set to | |
| | 0, device will not fire any PAUSE_WORK_SUBMISSION and RE- | |
| | SUME_WORK_SUBMISSION. | |
| | SW may set this bit to 1, if it implements the mechanisms to pause work | |
| | and resume work submissions on receiving PAUSE_WORK_SUBMIS- | |
| | SION and RESUME_WORK_SUBMISSION respectively. | |
| 1 | SDA_ENABLE | RW |
| | SW may set this bit to 1 to enable Suspend Device Acknowledgement capa- | |
| | bility. Enabling this, results in HW relying on receiving acknowledgement | |
| | from software clients (via DEVICE_SUPENDED register setting) before | |
| | firing a RESUME_WORK_SUBMISSION or set timer in | |
| | MIN_PAUSE_TIME (if TMR capability is enabled) expiring, whichever | |
| | comes first. | |
| 2 | TMR_ENABLE | RW |
| | SW may set this bit to 1 to enable TMR capability. Enabling this, results in | |
| | HW starting off a timer after firing PAUSE_WORK_SUBMISSION, count- | |
| | ing down from what is set in MIN_PAUSE_TIME. | |
| 7:3 | Reserved | RO |

Definition of the Device Suspended Register (16):

| Bit | Description | Attributes |
|---|---|---|
| 7 . . . 0 | DEVICE SUSPENDED | RW |
| | This register may be used by SW to indicate SW completion of processing | |
| | PAUSE_WORK_SUBMISSION. | |
| | If CAPABILITY. SDA bit is set to 1 and SW sets the CON- | |
| | TROL.SDA_ENABLE bit to 1, software must set this register to 1 to indi- | |
| | cate it has completed processing the PAUSE_WORK_SUBMISSION. Fur- | |
| | thermore, device HW will clear this register before firing a RE- | |
| | SUME_WORK_SUBMISSION. | |
| | If CAPABILITY. SDA bit is set to 0 or CONTROL.SDA_ENABLE bit is | |
| | set to 0, this register is not used. | |

Definition of the Device Suspended Register (17B):

| Bit | Description | Attributes |
|---|---|---|
| 23 . . . 0 | MIN_PAUSE_TIME | RW |
| | Minimum time from when PAUSE_WORK_SUBMISSION may be fired, | |
| | when a device can be guaranteed of no more new work submission from | |
| | SW. | |
| | HW may be initialized with a default reset value set in this register. Software | |
| | can reset this register to appropriate time deemed necessary to process the | |
| | PAUSE_WORK_SUBMISSION. The overwrite value must be greater than | |
| | the default setting for the overwrite to take into effect. | |
| | If CAPABILITY.SDA bit is ‘0’ or CONTROL.SDA_ENABLE bit is not | |
| | set to ‘ l’ and timer is supported by HW (CAPABILITY.TMR bit is set to | |
| | 1) , HW will ensure RESUME_WORK_SUBMISSION is not fired until at | |
| | least minimal time indicated in MIN_PAUSE_TIME has passed since firing | |
| | the PAUSE_WORK_SUBMISSION and HW is ready to accept new work. | |
| | If CAPABILITY.SDA bit and CONTROL.SDA_ENABLE bit are both set | |
| | to ‘1’, and timer is supported by HW (CAPABILITY.TMR bit is set to 1), | |
| | HW will use this MIN_PAUSE_TIME time between firing the | |
| | PAUSE_WORK_SUBMISSION and RESUME_WORK_SUBMISSION. | |
| | Thereby, unblocking the communication if SW fails to send an acknowl- | |
| | edgement (set Device Suspended register) of having completed processing | |
| | the PAUSE_WORK_SUBMISSION. | |

Optionally or alternatively, the mechanism to architecturally support can be integrated in the HW device registers, exposed through memory-mapped input/output (MMIO) space. The server can support this CAPABILITY and CONTROL register along with the acknowledgement register bit. The server may also choose to use the client supported command/status protocol to acknowledge processing of the PAUSE_WORK_SUBMISSION.

For example, if integrated in both, the PCI register and the HW register of a (physical) server, the HW may transmit the pause/resume interrupt based on the HW transitioning to inactive/active operation state respectively. In the case of a virtual device, these interrupts may be issued to the client, e.g., a guest/VM by the VMM, and the capabilities may be emulated in the PCI config space or the MMIO space.

In an example, the server may be a physical server, a virtual server, a physical PCI device, a physical compute express link device or a virtual device composed by a system software. For example, integration of interrupts can be supported on a virtual server or a physical server. As the interrupt can be supported on a virtual server, with no specific support needed in the physical server HW, the use of the interrupt can be leveraged on any platform which can no longer accommodate any new HW change, e.g., for supporting live migration or firmware update.

As shown in FIG. 1 the respective one or more interfaces 32 are coupled to the respective processing circuitry 34 at the server 30. In examples the processing circuitry 34 may be implemented using one or more processing units, one or more processing devices, any means for processing, such as a processor, a computer or a programmable hardware component being operable with accordingly adapted software. Similar, the described functions of the processing circuitry 34 may as well be implemented in software, which is then executed on one or more programmable hardware components. Such hardware components may comprise a general-purpose processor, a Digital Signal Processor (DSP), a micro-controller, etc. The processing circuitry 34 is capable of controlling the interface 32, so that any data transfer that occurs over the interface and/or any interaction in which the interface may be involved may be controlled by the processing circuitry 34.

In an embodiment the server 30 may comprise a memory and at least one processing circuitry 34 operably coupled to the memory and configured to perform the below mentioned method.

In examples the one or more interfaces 32 may correspond to any means for obtaining, receiving, transmitting or providing analog or digital signals or information, e.g. any connector, contact, pin, register, input port, output port, conductor, lane, etc. which allows providing or obtaining a signal or information. An interface may be wireless or wireline and it may be configured to communicate, e.g., transmit or receive signals, information with further internal or external components. The one or more interfaces 32 may comprise further components to enable communication between vehicles. Such components may include transceiver (transmitter and/or receiver) components, such as one or more Low-Noise Amplifiers (LNAs), one or more Power-Amplifiers (PAs), one or more duplexers, one or more diplexers, one or more filters or filter circuitry, one or more converters, one or more mixers, accordingly adapted radio frequency components, etc.

More details and aspects are mentioned in connection with the examples described below. The example shown in FIG. 1 may comprise one or more optional additional features corresponding to one or more aspects mentioned in connection with the proposed concept or one or more examples described below (e.g., FIG. 2-5).

FIG. 2 shows a block diagram of an example of a client 50. The client 50 comprises one or more interfaces 52 configured to communicate with a server (e.g., the server described with reference to FIG. 1), and processing circuitry 54 configured to control the one or more interfaces 52 and to receive an interrupt from the server informing about an operation state of the server. Thus, the client can be informed in an improved way about an operation state of the server.

The client may be a counterpart of the server described with reference to FIG. 1.

In an example, the interrupt may be a pause interrupt informing the client about an inactive operation state of the server. In an example, the information about the inactive operation state of the server may be information about a planned inactive operation state of the server.

In an example, the interrupt may be a resume interrupt informing about a termination of an inactive operation state of the server.

In an example, the processing circuitry 54 may be further configured to flush out all pending requests addressed to the server after receiving the pause interrupt.

In an example, the processing circuitry 54 may be further configured to transmit reception information about a processing of the interrupt to the server.

In an example, the reception information may further comprise information about a flush out of all pending requests of the client addressed to the server.

In an example, the processing circuitry 54 may be further configured to receive a request for the reception information.

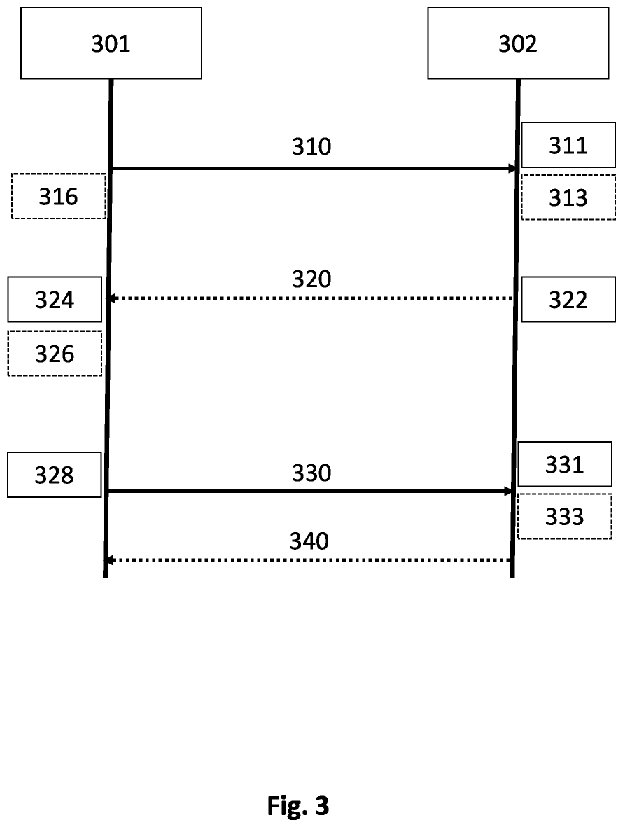

In an example, the client may comprise a kernel and wherein the processing circuitry 54 may be further configured to put the kernel into an inactive operation state (e.g., an idle operation state), such that the client can no longer transmit work/a request to the server. By putting the kernel in an idle operation state it can be guaranteed the client is no longer capable to transmit new work to the server (see also FIG. 3). Thus, it can be ensured in an eased way that the pause interrupt was processed correctly.

In an example, the processing circuitry may be further configured to queue each request for the server in a software queue. Thus, the request can be queued in an improved way and can be transmitted to the server after the server is an active operation state again (see also FIG. 3).

In an example, the processing circuitry 54 may further configured to transmit the software queue to the server after a termination of the inactive operation state of the server. For example, pending requests from the software queue can be transmitted individually or in combination (e.g., all together) to the server. Thus, the transmission of work to the server can be paused by the software queue and can be easily resumed.

In an example, the processing circuitry 54 may be further configured to process each request as long as the server is in the inactive operation state. Thus, the work can be processed by the client itself, as long as the server is in an inactive operation state. This way no work/request needs to be stored, e.g., in a software queue (see also FIG. 3).

In an example, the client may be a physical client or a virtual client. In an example, the client may be a driver, an application, a virtual machine, a container, a process or any combination of these.

As shown in FIG. 2 the respective one or more interfaces 52 are coupled to the respective processing circuitry 54 at the client 50. In examples the processing circuitry 54 may be implemented using one or more processing units, one or more processing devices, any means for processing, such as a processor, a computer or a programmable hardware component being operable with accordingly adapted software. Similar, the described functions of the processing circuitry 54 may as well be implemented in software, which is then executed on one or more programmable hardware components. Such hardware components may comprise a general-purpose processor, a Digital Signal Processor (DSP), a micro-controller, etc. The processing circuitry 54 is capable of controlling the interface 52, so that any data transfer that occurs over the interface and/or any interaction in which the interface may be involved may be controlled by the processing circuitry 54.

In an embodiment the client 50 may comprise a memory and at least one processing circuitry 54 operably coupled to the memory and configured to perform the below mentioned method.

In examples the one or more interfaces 52 may correspond to any means for obtaining, receiving, transmitting or providing analog or digital signals or information, e.g. any connector, contact, pin, register, input port, output port, conductor, lane, etc. which allows providing or obtaining a signal or information. An interface may be wireless or wireline and it may be configured to communicate, e.g., transmit or receive signals, information with further internal or external components. The one or more interfaces 52 may comprise further components to enable communication between vehicles. Such components may include transceiver (transmitter and/or receiver) components, such as one or more Low-Noise Amplifiers (LNAs), one or more Power-Amplifiers (PAs), one or more duplexers, one or more diplexers, one or more filters or filter circuitry, one or more converters, one or more mixers, accordingly adapted radio frequency components, etc.

More details and aspects are mentioned in connection with the examples described above and/or below. The example shown in FIG. 2 may comprise one or more optional additional features corresponding to one or more aspects mentioned in connection with the proposed concept or one or more examples described above (e.g., FIG. 1) and/or below (e.g., FIG. 3-5).

FIG. 3 shows a flow diagram of an example of a method 300. FIG. 3 provides a high-level overflow of the sequence involved in using a DCS feature to pause work submission using method 300.

The method 300 is performed by a server 301 (e.g., as described with reference to FIG. 1) and a client 302 (e.g., as described with reference to FIG. 2). In 310 the server 301 transmits a pause interrupt to the client 302, to inform the client 302 about an (planned) inactive operation state of its own. Optionally, a server pause timer may be set 316. Thus, a minimum timeout delay can be defined for the server 301 before entering an inactive operation state.

The client 302 receives the pause interrupt and may process 311 the pause interrupt resulting in a pause of transmitting work/request to the server 301. Optionally, a kernel of the client 302 may go 313 into an idle state, such that the client 302 cannot transmit any further work/request to the server 301.

The client 302 may set 322 a CAPABILITY SDA bit to 1 and the SW may have previously set control SDA_ENABLE bit and may send 320 reception information, e.g., acknowledgment, to the server 301. The server 301 may wait until reception information is received 320. Alternatively, if a server pause timer was set, the server may wait until the timeout delay has been expired. Further, if a server pause timer was set, the server 301 may reset/stop 326 the pause timer.

In 328 the server 301 may perform an operation, for which an inactive operations state is required, e.g., the server may perform a firmware update, a live migration, etc.

In 330 the server 301 transmits a resume interrupt to the client 302, informing the client 302 about a termination of the inactive operation state. The client 302 receives the resume interrupt and may process 331 the resume interrupt resulting in a resume of transmitting work/request to the server 301. Optionally, if the kernel of the client 302 was send into an idle operation state the kernel may terminate 333 the idle state and may resume work/request transmission to the server 301.

Optionally, the client 302 may transmit 340 reception information to the server 301 to inform the server about a resume of work/request transmission.

For example, in 310 a DCS feature can be used by a VMM to send the pause interrupt to the client 302, e.g., a VM SW (e.g., driver or application in user space), to cause the client 302 to stop submitting I/O request directly to the (assigned) server 301, e.g., a physical device.

As described, this can be used for supporting operation performed in 328, which require the server 301 to be in an inactive operation state, e.g., live migration of a guest (VM) that has an assigned physical device resource and guest SW clients are submitting workload to server 301. Using the support DCS, an architecturally supported mechanism (e.g., for live migration) can be implemented that may allow a server, e.g., virtual device, to be quiesced properly with no pending in flight request in the hardware and minimal operation state restoration once migrated to the destination host.

This architecturally supported mechanism is not restricted to physical device. For example a hypervisor and a virtual device composition module can create virtual device with the PR capability set, indicating virtual device support PAUSE_WORK_SUBMISSION, RESUME_WORK_SUBMISSION. Furthermore, Suspend Device Acknowledgement bit may also be set in the CAPABILITY register, indicating acknowledge from client is required after PAUSE_WORK_SUBMISSION is transmitted. Client SW can enable these capabilities in the driver along with enabling the timer (e.g., client pause timer or server pause timer) capability to prevent any possible deadlock due to failure to acknowledge the PAUSE_WORK SUBMISSION interrupt by client; Set DCS_ENABLE, SDA_ENABLE and TMR_ENABLE bits in CONTROL register to 1. Client can set the MIN_PAUSE_TIME to a value based on the time required to process pause work submission.

For example, a client SW may be expected to implement the support for the pause/resume interrupt by holding off and subsequently resuming submission of work to a virtual device.

With a support for the communication protocol, the pause interrupt and/or the resume interrupt can be used to notify a client of an operation state change of the server. The interrupt PAUSE_WORK_SUBMISSION indicates that a server, e.g., a device is paused. The client, e.g., a guest may be expected to ensure there is no submission of work to the HW of the server by all kernel of the client and user space clients. After the client has paused all work, it must notify a host that the virtual device is paused by setting the Interrupt RESUME_WORK_SUBMISSION indicating that the server, e.g. a device is resumed in an active operation state. The client may be expected to ensure submission of work to the HW of the server by all kernel of the client and user space client may be not hindered.

The client (e.g., guest) kernel driver can ensure that work is not submitted directly to the server, e.g., a virtual device HW in different ways. Following are 3 approaches of handling this in guest software.

First approach is to prevent/block work submission. A guest kernel driver can unmap the work submission portal (e.g., the doorbell register for work submission) from the guest user space. If the guest user apps/threads try to submit work to the portal, it will cause a page fault which will be forwarded to the guest kernel driver for handling. The guest kernel driver can put the submitter thread to sleep until the VM is migrated and resumed on the destination machine.

Further the guest kernel driver can put the guest kernel threads to sleep after receiving the ‘PAUSE_WORK_SUBMISSION’ interrupt. Since all guest kernel clients submit their work through the guest kernel driver, guest kernel driver can easily stop the clients from submitting work.

The second approach is to queue the work. On receiving a PAUSE_WORK_SUBMISSION the guest may change the operation state of the server to device suspended. The kernel driver may notify the user client of the change in the operation state of the server. In this operation state, instead of submitting the work to the HW of the server, guests may queue up all the work/requests in a software queue.

On receiving a RESUME_WORK_SUBMISSION guests may first submit all previously queued request to the HW of the server. The kernel driver will notify all user space clients of the change of device state. The guest may then then shift to the operation state of the server to device resume and resume submitting work directly to HW of the server.

Further, an order of work submission across multiple clients can be maintained. For example, this can be done via storing the order in which the work/requests get queued in each client's queue and on receiving a RESUME_WORK_SUBMISSION the queued requests may be transmitted in the order they were queued in.

Further, a transition point where all client software queues are drained (all work submitted to the HW of the server) completely before allowing direct submission to the HW of the server can be identified. Thus, it can be ensured that the order of submission is maintained, e.g., previously queued work is submitted before any new work is submitted directly to HW of the server.

A third approach is the use of an emulated mode in guest. For example, on receiving a PAUSE_WORK_SUBMISSION the guest may change the operation state of the server to device suspended. The kernel driver may notify a user of the guest of the change in the operation state of the server. In this operation state, instead of submitting the work to the HW of the server, the guest may process the work using a software implementation of the operation supported by the HW of the server.

On receiving a RESUME_WORK_SUBMISSION the guest may shift the operation state of the server to device resume. The kernel driver may notify all user space guest of the change of the device state of the server and may submit all work directly to the HW of the server.

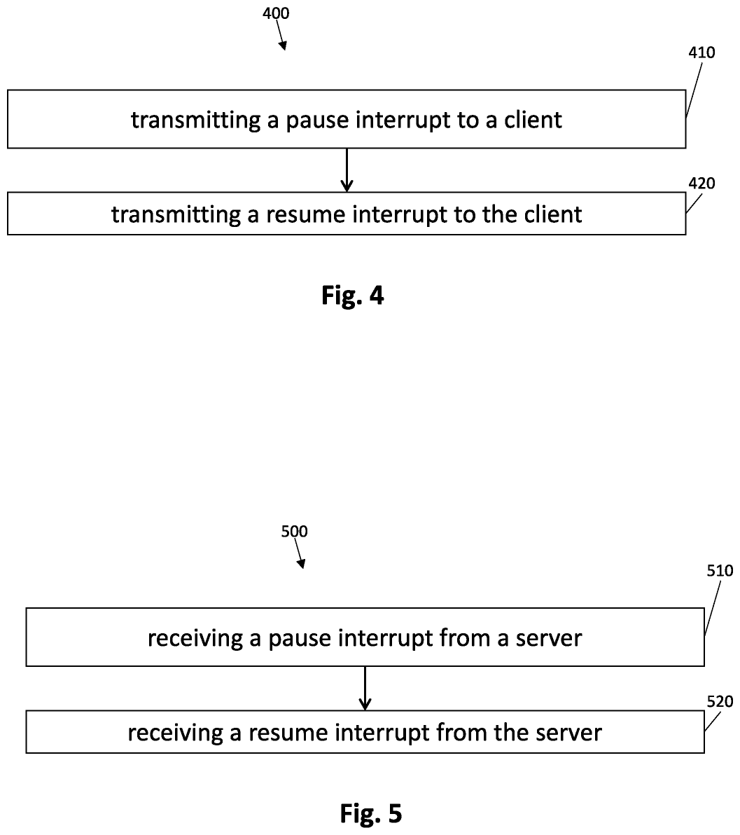

More details and aspects are mentioned in connection with the examples described above and/or below. The example shown in FIG. 3 may comprise one or more optional additional features corresponding to one or more aspects mentioned in connection with the proposed concept or one or more examples described above (e.g., FIGS. 1-2) and/or below (e.g., FIG. 4-5).

FIG. 4 shows a block diagram of an example of a method 400 for a server. The method 400 comprises transmitting 410 a pause interrupt to a client and transmitting 420 a resume interrupt to the client.

In an example, the method 400 may further comprise receiving reception information about a processing of the pause interrupt from the client.

More details and aspects are mentioned in connection with the examples described above and/or below. The example shown in FIG. 4 may comprise one or more optional additional features corresponding to one or more aspects mentioned in connection with the proposed concept or one or more examples described above (e.g., FIGS. 1-3) and/or below (e.g., FIG. 5).

FIG. 5 shows a block diagram of an example of a method 500 for a client. The method comprises receiving 510 a pause interrupt from a server and receiving 520 a resume interrupt from the server.

In an example, the method 500 may further comprise transmitting reception information about a processing of the pause interrupt to the server.

More details and aspects are mentioned in connection with the examples described above. The example shown in FIG. 5 may comprise one or more optional additional features corresponding to one or more aspects mentioned in connection with the proposed concept or one or more examples described above (e.g., FIG. 1-4).

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

As used in this application and the claims, a list of items joined by the term “and/or” can mean any combination of the listed items. For example, the phrase “A, B and/or C” can mean A; B; C; A and B; A and C; B and C; or A, B and C. As used in this application and the claims, a list of items joined by the term “at least one of” can mean any combination of the listed terms. For example, the phrase “at least one of A, B or C” can mean A; B; C; A and B; A and C; B and C; or A, B, and C. Moreover, as used in this application and the claims, a list of items joined by the term “one or more of” can mean any combination of the listed terms. For example, the phrase “one or more of A, B and C” can mean A; B; C; A and B; A and C; B and C; or A, B, and C.

The disclosed methods, apparatuses, and systems are not to be construed as limiting in any way. Instead, the present disclosure is directed toward all novel and nonobvious features and aspects of the various disclosed embodiments, alone and in various combinations and subcombinations with one another. The disclosed methods, apparatuses, and systems are not limited to any specific aspect or feature or combination thereof, nor do the disclosed embodiments require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

Although the operations of some of the disclosed methods are described in a particular, sequential order for convenient presentation, it is to be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

An example (e.g., example 1) relates to a server, comprising one or more interfaces configured to communicate with a client and processing circuitry configured to control the one or more interfaces and to transmit an interrupt to the client informing the client about an operation state of the server.

Another example (e.g., example 2) relates to a previously described example (e.g., example 1) wherein the interrupt is a pause interrupt informing the client about an inactive operation state of the server.

Another example (e.g., example 3) relates to a previously described example (e.g., one of the examples 1-2) wherein the information about the inactive operation state of the server is information about a planned inactive operation state of the server.

Another example (e.g., example 4) relates to a previously described example (e.g., one of the examples 1-3) wherein the interrupt is a resume interrupt informing the client about a termination of an inactive operation state of the server.

Another example (e.g., example 5) relates to a previously described example (e.g., one of the examples 2-4) wherein the processing circuitry is further configured to receive reception information about a processing of the interrupt from the client.

Another example (e.g., example 6) relates to a previously described example (e.g., the example 5) wherein the processing circuitry is further configured to request the reception information.

Another example (e.g., example 7) relates to a previously described example (e.g., one of the examples 5 or 6) wherein the reception information further comprises information about a flush out of all pending requests of the client addressed to the server.

Another example (e.g., example 8) relates to a previously described example (e.g., one of the examples 5-7) wherein the processing circuitry is further configured to allow the server to enter the inactive operation state only after receiving the reception information.

Another example (e.g., example 9) relates to a previously described example (e.g., one of the examples 2-8) wherein the processing circuitry is further configured to transmit a client pause timer to the client, wherein the client pause timer defines a minimum time delay between receiving the pause request and transmitting a new request to the server.

Another example (e.g., example 10) relates to a previously described example (e.g., the example 9) wherein the processing circuitry is further configured to define the minimum time delay of the client pause timer.

Another example (e.g., example 11) relates to a previously described example (e.g., one of the examples 2-10) wherein the processing circuitry is further configured to use a server pause timer, wherein the server pause timer defines a minimum time delay between transmitting the pause request and entering the inactive operation state.

Another example (e.g., example 12) relates to a previously described example (e.g., the example 11) wherein the processing circuitry is further configured to receive the minimum time delay of the server pause timer from the client.

Another example (e.g., example 13) relates to a previously described example (e.g., one of the examples 1-12) wherein the processing circuitry is further configured to transmit the interrupt by use of a peripheral component interconnect, PCI, register and/or a server register, which is exposed through memory-mapped input/output.

Another example (e.g., example 14) relates to a previously described example (e.g., the example 13) wherein the processing circuitry is further configured to set the PCI register and/or the server register to indicate a support of the interrupt.

Another example (e.g., example 15) relates to a previously described example (e.g., one of the examples 13 or 14) wherein the processing circuitry is further configured to set the PCI register and/or the server register to indicate a support of the reception information.

Another example (e.g., example 16) relates to a previously described example (e.g., one of the examples 13-15) wherein the processing circuitry is further configured to set the PCI register and/or the server register to indicate required reception information about receiving the interrupt from the client.

Another example (e.g., example 17) relates to a previously described example (e.g., one of the examples 1-16) wherein the server is a physical server, a virtual server, a physical PCI device, a physical compute express link device or a virtual device composed by a system software.

An example (e.g., example 18) relates to a client, comprising one or more interfaces configured to communicate with a server, and processing circuitry configured to control the one or more interfaces and to receive an interrupt from the server informing about an operation state of the server.

Another example (e.g., example 19) relates to a previously described example (e.g., the example 18) wherein the interrupt is a pause interrupt informing the client about an inactive operation state of the server.

Another example (e.g., example 20) relates to a previously described example (e.g., the examples 19) wherein the information about the inactive operation state of the server is information about a planned inactive operation state of the server.

Another example (e.g., example 21) relates to a previously described example (e.g., one of the examples 18-20) wherein the interrupt is a resume interrupt informing about a termination of an inactive operation state of the server.

Another example (e.g., example 22) relates to a previously described example (e.g., one of the examples 19-21) wherein the processing circuitry is further configured to flush out all pending requests addressed to the server after receiving the pause interrupt.

Another example (e.g., example 23) relates to a previously described example (e.g., one of the examples 19-22) wherein the processing circuitry is further configured to transmit reception information about a processing of the interrupt to the server.

Another example (e.g., example 24) relates to a previously described example (e.g., the example 23) wherein the reception information further comprises information about a flush out of all pending requests of the client addressed to the server.

Another example (e.g., example 25) relates to a previously described example (e.g., one of the examples 23 or 24) wherein the processing circuitry is further configured to receive a request for the reception information.

Another example (e.g., example 26) relates to a previously described example (e.g., one of the examples 19-25) wherein the client comprises a kernel and wherein the processing circuitry is further configured to put the kernel into an inactive operation state, such that the client can no longer transmit a request to the server.

Another example (e.g., example 27) relates to a previously described example (e.g., one of the examples 19-26) wherein the processing circuitry is further configured to queue each request for the server in a software queue.

Another example (e.g., example 28) relates to a previously described example (e.g., the example 27) wherein the processing circuitry is further configured to transmit the software queue to the server after a termination of the inactive operation state of the server.

Another example (e.g., example 29) relates to a previously described example (e.g., one of the examples 19-28) wherein the processing circuitry is further configured to process each request as long as the server is in the inactive operation state.

Another example (e.g., example 30) relates to a previously described example (e.g., one of the examples 19-29) wherein the client is a physical client or a virtual client.

Another example (e.g., example 31) relates to a previously described example (e.g., one of the examples 19-30) wherein the client is a driver, a virtual machine, an application, a container, a process or any combination of these.

An example (e.g., example 32) relates to a method (for a server), comprising transmitting an interrupt to a client informing the client about an operation state of the server.

Another example (e.g., example 33) relates to a previously described example (e.g., example 32) wherein the interrupt is a pause interrupt informing the client about a quiesce state of the server.

Another example (e.g., example 34) relates to a previously described example (e.g., example 33) wherein the information about the inactive operation state of the server is information about a planned inactive operation state of the server.

Another example (e.g., example 35) relates to a previously described example (e.g., one of the examples 32-34) wherein the interrupt is a resume interrupt informing the client about a termination of an inactive operation state of the server.

Another example (e.g., example 36) relates to a previously described example (e.g., the example 35) further comprising transmitting a further interrupt, wherein the interrupt is a pause interrupt and the further interrupt is a resume interrupt.

Another example (e.g., example 37) relates to a previously described example (e.g., one of the examples 33-36) further comprising receiving reception information about a processing of the pause interrupt from the client.

Another example (e.g., example 38) relates to a previously described example (e.g., the example 37) further comprising requesting the reception information.

Another example (e.g., example 39) relates to a previously described example (e.g., one of the examples 37 or 38) wherein the reception information further comprises information about a flush out of all pending requests of the client addressed to the server.

Another example (e.g., example 40) relates to a previously described example (e.g., one of the examples 37-39) further comprising allowing the server to enter the inactive operation state only after receiving the reception information.

Another example (e.g., example 41) relates to a previously described example (e.g., one of the examples 34-40) further comprising transmitting a client pause timer to the client, wherein the client pause timer defines a minimum time delay between receiving the pause request and transmitting a new request to the server.

Another example (e.g., example 42) relates to a previously described example (e.g., the example 41) further comprising defining the minimum time delay of the client pause timer.

Another example (e.g., example 43) relates to a previously described example (e.g., one of the examples 33-42) further comprising using a server pause timer, wherein the server pause timer defines a minimum time delay between transmitting the pause request and entering the inactive operation state.

Another example (e.g., example 44) relates to a previously described example (e.g., the example 43) further comprising receiving the minimum time delay of the server pause timer from the client.

Another example (e.g., example 45) relates to a previously described example (e.g., one of the examples 32-44) wherein the processing circuitry is further configured to transmit the interrupt by use of a peripheral component interconnect, PCI, register and/or a server register, which is exposed through memory-mapped input/output.

Another example (e.g., example 46) relates to a previously described example (e.g., the example 45) further comprising setting the PCI register and/or the server register to indicate a support of the interrupt.

Another example (e.g., example 47) relates to a previously described example (e.g., one of the examples 45-46) further comprising setting the PCI register and/or the server register to indicate a support of the reception information.

Another example (e.g., example 48) relates to a previously described example (e.g., one of the examples 45-47) further comprising setting the PCI register and/or the server register to indicate required reception information about receiving the interrupt from the client.

An example (e.g., example 49) relates to a non-transitory, computer-readable medium comprising a program code that, when the program code is executed on a computer, a processor, or a programmable hardware component, performs one of the above examples (e.g., one of the examples 32-48).

An example (e.g., example 50) relates to a method (for a client), comprising receiving an interrupt from a server informing the client about an operation state of the server.

Another example (e.g., example 51) relates to a previously described example (e.g., example 50) wherein the interrupt is a pause interrupt informing the client about a quiesce state of the server.

Another example (e.g., example 52) relates to a previously described example (e.g., example 51) wherein the information about the inactive operation state of the server is information about a planned inactive operation state of the server.

Another example (e.g., example 53) relates to a previously described example (e.g., one of the examples 50-52) wherein the interrupt is a resume interrupt informing the client about a termination of an inactive operation state of the server.

Another example (e.g., example 54) relates to a previously described example (e.g., the example 53) further comprising receiving a further interrupt from the server, wherein the interrupt is a pause interrupt and the further interrupt is a resume interrupt.

Another example (e.g., example 55) relates to a previously described example (e.g., one of the examples 51-54) further comprising flushing out all pending requests addressed to the server after receiving the pause interrupt.

Another example (e.g., example 56) relates to a previously described example (e.g., one of the examples 51-55) further comprising transmitting reception information about a processing of the interrupt to the server.

Another example (e.g., example 57) relates to a previously described example (e.g., the example 56) wherein the reception information further comprises information about a flush out of all pending requests of the client addressed to the server.

Another example (e.g., example 58) relates to a previously described example (e.g., one of the examples 56 or 57) further comprising receiving a request for the reception information.

Another example (e.g., example 59) relates to a previously described example (e.g., one of the examples 51-58) wherein the client comprises a kernel and further comprising putting the kernel into an inactive operation state, such that the client can no longer transmit a request to the server.

Another example (e.g., example 60) relates to a previously described example (e.g., one of the examples 51-59) further comprising queuing each request for the server in a software queue.

Another example (e.g., example 61) relates to a previously described example (e.g., the example 60) further comprising transmitting the software queue to the server after a termination of the inactive operation state of the server.

Another example (e.g., example 62) relates to a previously described example (e.g., one of the examples 51-61) further comprising processing each request as long as the server is in the inactive operation state.

An example (e.g., example 63) relates to a non-transitory, computer-readable medium comprising a program code that, when the program code is executed on a computer, a processor, or a programmable hardware component, performs one of the above examples (e.g., one of the examples 51-62)

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

1. A server, comprising
one or more interfaces configured to communicate with a client; and
processing circuitry configured to control the one or more interfaces and to transmit an interrupt to the client informing the client about an operation state of the server.

2. The server according to claim 1, the processing circuitry is further configured to transmit the interrupt by use of a peripheral component interconnect, PCI, register and/or a server register, which is exposed through memory-mapped input/output.

3. The server according to claim 1, wherein the interrupt is a pause interrupt informing the client about an inactive operation state of the server.

4. The server according to claim 3, wherein the information about the inactive operation state of the server is information about a planned inactive operation state of the server.

5. The server according to claim 1, wherein the interrupt is a resume interrupt informing the client about a termination of an inactive operation state of the server.

6. The server according to claim 3, wherein the processing circuitry is further configured to receive reception information about a processing of the interrupt from the client.

7. The server according to claim 6, wherein the reception information further comprises information about a flush out of all pending requests of the client addressed to the server.

8. The server according to claim 3, wherein
the processing circuitry is further configured to transmit a client pause timer to the client, wherein the client pause timer defines a minimum time delay between receiving the pause request and transmitting a new request to the server.

9. The server according to claim 3, wherein
the processing circuitry is further configured to use a server pause timer, wherein the server pause timer defines a minimum time delay between transmitting the pause request and entering the inactive operation state.

10. The server according to claim 1, wherein the processing circuitry is further configured to set the PCI register and/or the server register to indicate a support of the interrupt, a support of the reception information and/or a required reception information about receiving the interrupt from the client.

11. The server according to claim 1, wherein the server is a physical server, a virtual server, a physical PCI device, a physical compute express link device or a virtual device composed by a system software.

12. A client, comprising
one or more interfaces configured to communicate with a server, and
processing circuitry configured to control the one or more interfaces and to receive an interrupt from the server informing about an operation state of the server.

13. The client according to claim 12, wherein the interrupt is a pause interrupt informing the client about the inactive operation state of the server.

14. The client according to claim 13, wherein the processing circuitry is further configured to flush out all pending requests addressed to the server after receiving the pause interrupt.

15. The client according to claim 12, wherein the client comprises a kernel and wherein the processing circuitry is further configured to put the kernel into an inactive operation state such that the client can no longer transmit a request to the server.

16. The client according to claim 12, wherein the processing circuitry is further configured to queue each request for the server in a software queue.

17. The client according to claim 16, wherein the processing circuitry is further configured to transmit the software queue to the server after a termination of the inactive operation state of the server.

18. The client according to claim 12, wherein the processing circuitry is further configured to process each request as long as the server is in the inactive operation state.

19. The client according to claim 12, wherein the client is a physical client or a virtual client.

20. A method, comprising
transmitting a pause interrupt to a client; and
transmitting a resume interrupt to the client.

21. The method according to claim 20, further comprising receiving reception information about a processing of the pause interrupt from the client.

22. A non-transitory, computer-readable medium comprising a program code that, when the program code is executed on a computer, a processor, or a programmable hardware component, performs the method of claim 20.

23. A method, comprising
receiving a pause interrupt from a server; and
receiving a resume interrupt from the server.

24. The method according to claim 23, further comprising transmitting reception information about a processing of the pause interrupt to the server.

25. A non-transitory, computer-readable medium comprising a program code that, when the program code is executed on a computer, a processor, or a programmable hardware component, performs the method of claim 23.
